(19) United States
(12) Patent Application Publication
(10) Pub. No.: US 2026/0035277 A1
(43) Pub. Date: Feb. 5, 2026

(54) PUSHING ASSEMBLY AND METHOD FOR GLASS MELTING FURNACE ELECTRODES

(71) Applicant: CORNING INCORPORATED, CORNING, NY (US)

(72) Inventor: Kevin Scott Riegel, Owego, NY (US)

(21) Appl. No.: 19/100,200

(22) PCT Filed: Aug. 15, 2023
(86) PCT No.: PCT/US2023/030206

§ 371 Date: Jan. 31, 2025

Related U.S. Application Data
(60) Provisional application No. 63/373,381, filed on Aug. 24, 2022.

(51) Int. Cl. C03B 5/185; C03B 5/027

(52) U.S. Cl. CPC C03B 5/185; C03B 5/027

(57) ABSTRACT

An electrode pushing assembly and method includes a frame assembly, a plurality of driving assemblies fixedly coupled to the frame assembly, and a push frame coupled to the plurality of driving assemblies and configured to exert a pushing force against the electrode. The plurality of driving assemblies are configured to move the push frame and are each independently removable from the frame assembly and the push frame.

### CROSS-REFERENCE TO RELATED APPLICATIONS

This application claims the benefit of priority under 35 U.S.C. § 119 of U.S. Provisional Application Ser. No. 63/373,381 filed on Aug. 24, 2022, the content of which is relied upon and incorporated herein by reference in its entirety.

### FIELD

The present disclosure relates generally to a pushing assembly and method for glass melting furnace electrodes.

### BACKGROUND

In the production of glass articles, such as glass sheets for display applications, including televisions and hand-held devices, such as telephones and tablets, a glass composition is typically melted to form molten glass in a melting vessel that includes a plurality of electrodes. During operation of the melting vessel, portions of the electrodes that are exposed to the molten glass gradually corrode over time. Compensation for such corrosion can be achieved by using a mechanism to push the electrodes toward the melted glass composition. Because of the complexity and expense of implementing and operating such a mechanism, improvements are continually desired.

### SUMMARY

Embodiments disclosed herein include an electrode pushing assembly. The electrode pushing assembly includes a frame assembly. The electrode pushing assembly also includes a plurality of driving assemblies fixedly coupled to the frame assembly. In addition, the electrode pushing assembly includes a push frame coupled to the plurality of driving assemblies and configured to exert a pushing force against the electrode. The plurality of driving assemblies are configured to move the push frame and are each independently removable from the frame assembly and the push frame.

Embodiments disclosed herein also include a method of pushing an electrode. The method includes exerting a pushing force against the electrode with a push frame that is coupled to a plurality of driving assemblies. The plurality of driving assemblies are fixedly coupled to a frame assembly. The plurality of driving assemblies move the push frame and are each independently removable from the frame assembly and the push frame.

Additional features and advantages of the embodiments disclosed herein will be set forth in the detailed description which follows, and in part will be readily apparent to those skilled in the art from that description or recognized by practicing the disclosed embodiments as described herein, including the detailed description which follows, the claims, as well as the appended drawings.

It is to be understood that both the foregoing general description and the following detailed description present embodiments intended to provide an overview or framework for understanding the nature and character of the claimed embodiments. The accompanying drawings are included to provide further understanding, and are incorporated into and constitute a part of this specification. The drawings illustrate various embodiments of the disclosure, and together with the description explain the principles and operations thereof.

### BRIEF DESCRIPTION OF THE DRAWINGS

FIG. 1 is a schematic view of an example fusion down draw glass-making apparatus and process;

FIG. 2 is a schematic side cutaway view of an example glass melting vessel in accordance with embodiments disclosed herein:

FIG. 3 is schematic top cutaway view of the example glass melting vessel of FIG. 2:

FIG. 4 is schematic end cutaway view of the example glass melting vessel of FIGS. 2-3:

FIG. 5 is a schematic side cutaway view of an electrode and pushing mechanism:

FIG. 6 is a schematic side view of an exemplary electrode and pushing assembly in accordance with embodiments disclosed herein;

FIG. 7 is a schematic top view of an exemplary electrode and pushing assembly in accordance with embodiments disclosed herein;

FIG. 8 is a schematic end view of an exemplary electrode and pushing assembly in accordance with embodiments disclosed herein;

FIG. 9 is a schematic side view of an exemplary driving assembly in accordance with embodiments disclosed herein:

FIG. 10 is a schematic side view of an exemplary driving assembly in accordance with embodiments disclosed herein:

FIG. 11 is a schematic end cutaway view of a portion of an exemplary electrode pushing assembly in accordance with embodiments disclosed herein:

FIGS. 12A and 12B are schematic side cutaway views of a portion of an exemplary electrode pushing assembly in accordance with embodiments disclosed herein;

FIG. 13 is a schematic top view of an exemplary electrode and pushing assembly wherein a driving assembly has been removed in accordance with embodiments disclosed herein:

FIG. 14 is a schematic side view of an exemplary electrode and pushing assembly wherein a plurality of driving assemblies have been removed in accordance with embodiments disclosed herein; and

FIG. 15 is a schematic side view of an exemplary electrode and pushing assembly wherein a plurality of driving assemblies and a push frame have been removed in accordance with embodiments disclosed herein.

### DETAILED DESCRIPTION

Reference will now be made in detail to embodiments of the present disclosure, examples of which are illustrated in the accompanying drawings. Whenever possible, the same reference numerals will be used throughout the drawings to refer to the same or like parts. However, this disclosure may be embodied in many different forms and should not be construed as limited to the embodiments set forth herein.

Ranges can be expressed herein as from “about” one particular value, and/or to “about” another particular value. When such a range is expressed, another embodiment includes from the one particular value and/or to the other particular value. Similarly, when values are expressed as approximations, for example by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components: plain meaning derived from grammatical organization or punctuation, and: the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

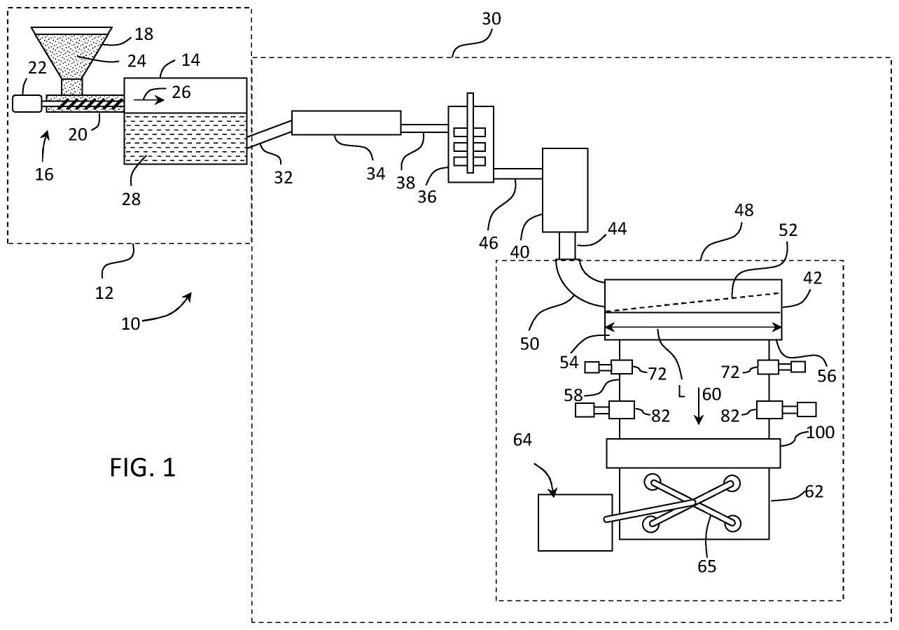

Shown in FIG. 1 is an exemplary glass manufacturing apparatus 10. In some examples, the glass manufacturing apparatus 10 can comprise a glass melting furnace 12 that can include a melting vessel 14. Glass melting furnace 12 including melting vessel 14 can include one or more additional components such as heating elements or mechanisms (e.g., combustion burners or electrodes) that heat raw materials and convert the raw materials into molten glass. In further examples, glass melting furnace 12 may include thermal management devices (e.g., insulation components) that reduce heat lost from a vicinity of the melting vessel. In still further examples, glass melting furnace 12 may include electronic devices and/or electromechanical devices that facilitate melting of the raw materials into a glass melt. Still further, glass melting furnace 12 may include support structures (e.g., support chassis, support member, etc.) or other components.

Glass melting vessel 14 is typically comprised of refractory material, such as a refractory ceramic material, for example a refractory ceramic material comprising alumina or zirconia. In some examples glass melting vessel 14 may be constructed from refractory ceramic bricks. Specific embodiments of glass melting vessel 14 will be described in more detail below.

In some examples, the glass melting furnace may be incorporated as a component of a glass manufacturing apparatus to fabricate a glass substrate, for example a glass ribbon of a continuous length. In some examples, the glass melting furnace of the disclosure may be incorporated as a component of a glass manufacturing apparatus comprising a slot draw apparatus, a float bath apparatus, a down-draw apparatus such as a fusion process, an up-draw apparatus, a press-rolling apparatus, a tube drawing apparatus or any other glass manufacturing apparatus that would benefit from the aspects disclosed herein. By way of example, FIG. 1 schematically illustrates glass melting furnace 12 as a component of a fusion down-draw glass manufacturing apparatus 10 for fusion drawing a glass ribbon for subsequent processing into individual glass sheets.

The glass manufacturing apparatus 10 (e.g., fusion down-draw apparatus 10) can optionally include an upstream glass manufacturing apparatus 16 that is positioned upstream relative to glass melting vessel 14. In some examples, a portion of, or the entire upstream glass manufacturing apparatus 16, may be incorporated as part of the glass melting furnace 12.

As shown in the illustrated example, the upstream glass manufacturing apparatus 16 can include a storage bin 18, a raw material delivery device 20 and a motor 22 connected to the raw material delivery device. Storage bin 18 may be configured to store a quantity of raw materials 24 that can be fed into melting vessel 14 of glass melting furnace 12, as indicated by arrow 26. Raw materials 24 typically comprise one or more glass forming metal oxides and one or more modifying agents. In some examples, raw material delivery device 20 can be powered by motor 22 such that raw material delivery device 20 delivers a predetermined amount of raw materials 24 from the storage bin 18 to melting vessel 14. In further examples, motor 22 can power raw material delivery device 20 to introduce raw materials 24 at a controlled rate based on a level of molten glass sensed downstream from melting vessel 14. Raw materials 24 within melting vessel 14 can thereafter be heated to form molten glass 28.

Glass manufacturing apparatus 10 can also optionally include a downstream glass manufacturing apparatus 30 positioned downstream relative to glass melting furnace 12. In some examples, a portion of downstream glass manufacturing apparatus 30 may be incorporated as part of glass melting furnace 12. In some instances, first connecting conduit 32 discussed below, or other portions of the downstream glass manufacturing apparatus 30, may be incorporated as part of glass melting furnace 12. Elements of the downstream glass manufacturing apparatus, including first connecting conduit 32, may be formed from a precious metal. Suitable precious metals include platinum group metals selected from the group of metals consisting of platinum, iridium, rhodium, osmium, ruthenium and palladium, or alloys thereof. For example, downstream components of the glass manufacturing apparatus may be formed from a platinum-rhodium alloy including from about 70 to about 90% by weight platinum and about 10% to about 30% by weight rhodium. However, other suitable metals can include molybdenum, palladium, rhenium, tantalum, titanium, tungsten and alloys thereof.

Downstream glass manufacturing apparatus 30 can include a first conditioning (i.e., processing) vessel, such as fining vessel 34, located downstream from melting vessel 14 and coupled to melting vessel 14 by way of the above-referenced first connecting conduit 32. In some examples, molten glass 28 may be gravity fed from melting vessel 14 to fining vessel 34 by way of first connecting conduit 32. For instance, gravity may cause molten glass 28 to pass through an interior pathway of first connecting conduit 32 from melting vessel 14 to fining vessel 34. However, other conditioning vessels may be positioned downstream of melting vessel 14, for example between melting vessel 14 and fining vessel 34. In some embodiments, a conditioning vessel may be employed between the melting vessel and the fining vessel wherein molten glass from a primary melting vessel is further heated to continue the melting process or cooled to a temperature lower than the temperature of the molten glass in the melting vessel before entering the fining vessel.

Bubbles may be removed from molten glass 28 within fining vessel 34 by various techniques. For example, raw materials 24 may include multivalent compounds (i.e., fining agents) such as tin oxide that, when heated, undergo a chemical reduction reaction and release oxygen. Other suitable fining agents include without limitation arsenic, antimony, iron, and cerium. Fining vessel 34 is heated to a temperature greater than the melting vessel temperature, thereby heating the molten glass and the fining agent. Oxygen produced by the temperature-induced chemical reduction of the fining agent(s) can diffuse or coalesce into bubbles produced in the molten glass during the melting process. The enlarged gas bubbles can then rise to a free surface of the molten glass in the fining vessel and thereafter be vented out of the fining vessel. The bubbles can further induce mechanical mixing of the molten glass in the fining vessel.

Downstream glass manufacturing apparatus 30 can further include another conditioning vessel such as a mixing vessel 36 for mixing the molten glass. Mixing vessel 36 may be located downstream from the fining vessel 34. Mixing vessel 36 can be used to provide a homogenous glass melt composition, thereby reducing cords of chemical or thermal inhomogeneity that may otherwise exist within the fined molten glass exiting the fining vessel. As shown, fining vessel 34 may be coupled to mixing vessel 36 by way of a second connecting conduit 38. In some examples, molten glass 28 may be gravity fed from the fining vessel 34 to mixing vessel 36 by way of second connecting conduit 38. For instance, gravity may cause molten glass 28 to pass through an interior pathway of second connecting conduit 38 from fining vessel 34 to mixing vessel 36. While mixing vessel 36 is shown downstream of fining vessel 34, mixing vessel 36 may be positioned upstream from fining vessel 34. In some embodiments, downstream glass manufacturing apparatus 30 may include multiple mixing vessels, for example a mixing vessel upstream from fining vessel 34 and a mixing vessel downstream from fining vessel 34. These multiple mixing vessels may be of the same design, or they may be of different designs.

Downstream glass manufacturing apparatus 30 can further include another conditioning vessel such as delivery vessel 40 that may be located downstream from mixing vessel 36. Delivery vessel 40 may condition molten glass 28 to be fed into a downstream forming device. For instance, delivery vessel 40 can act as an accumulator and/or flow controller to adjust and/or provide a consistent flow of molten glass 28 to forming body 42 by way of exit conduit 44. As shown, mixing vessel 36 may be coupled to delivery vessel 40 by way of third connecting conduit 46. In some examples, molten glass 28 may be gravity fed from mixing vessel 36 to delivery vessel 40 by way of third connecting conduit 46. For instance, gravity may drive molten glass 28 through an interior pathway of third connecting conduit 46 from mixing vessel 36 to delivery vessel 40.

Downstream glass manufacturing apparatus 30 can further include forming apparatus 48 comprising the above-referenced forming body 42 and inlet conduit 50. Exit conduit 44 can be positioned to deliver molten glass 28 from delivery vessel 40 to inlet conduit 50 of forming apparatus 48. For example, exit conduit 44 may be nested within and spaced apart from an inner surface of inlet conduit 50, thereby providing a free surface of molten glass positioned between the outer surface of exit conduit 44 and the inner surface of inlet conduit 50. Forming body 42 in a fusion down draw glass-making apparatus can comprise a trough 52 positioned in an upper surface of the forming body 42 and converging forming surfaces 54 that converge in a draw direction along a bottom edge 56 of the forming body 42. Molten glass delivered to the forming body trough via delivery vessel 40, exit conduit 44 and inlet conduit 50 overflows side walls of the trough and descends along the converging forming surfaces 54 as separate flows of molten glass. The separate flows of molten glass join below and along bottom edge 56 to produce a single ribbon of glass 58 that is drawn in a draw or flow direction 60 from bottom edge 56 by applying tension to the glass ribbon, such as by gravity, edge rolls 72 and pulling rolls 82, to control the dimensions of the glass ribbon as the glass cools and a viscosity of the glass increases. Accordingly, glass ribbon 58 goes through a visco-elastic transition and acquires mechanical properties that give the glass ribbon 58 stable dimensional characteristics. Glass ribbon 58 may, in some embodiments, be separated into individual glass sheets 62 by a glass separation apparatus 100 in an elastic region of the glass ribbon. A robot 64 may then transfer the individual glass sheets 62 to a conveyor system using gripping tool 65, whereupon the individual glass sheets may be further processed.

FIG. 2 shows a schematic side cutaway view of an example glass melting vessel 14 in accordance with embodiments disclosed herein. Glass melting vessel 14 includes a chamber 114 positioned above a floor 126, wherein raw material delivery device 20 delivers a predetermined amount of raw batch materials 24 into the chamber 114 through feed port 116, wherein the combination of raw material delivery device 20 and feed port 116 comprises a feeding mechanism. Glass melting vessel 14 also includes a plurality of electrodes 102 and a plurality of combustion burners 104.

In operation, plurality of electrodes 102 and plurality of combustion burners 104 heat chamber 114 such that raw batch materials 24 are melted into molten glass 28 up to a predetermined depth (L) within chamber 114. As can be seen in FIG. 2, plurality of combustion burners 104 are positioned above the predetermined depth (L) and plurality of electrodes 102 are positioned below the predetermined depth (L).

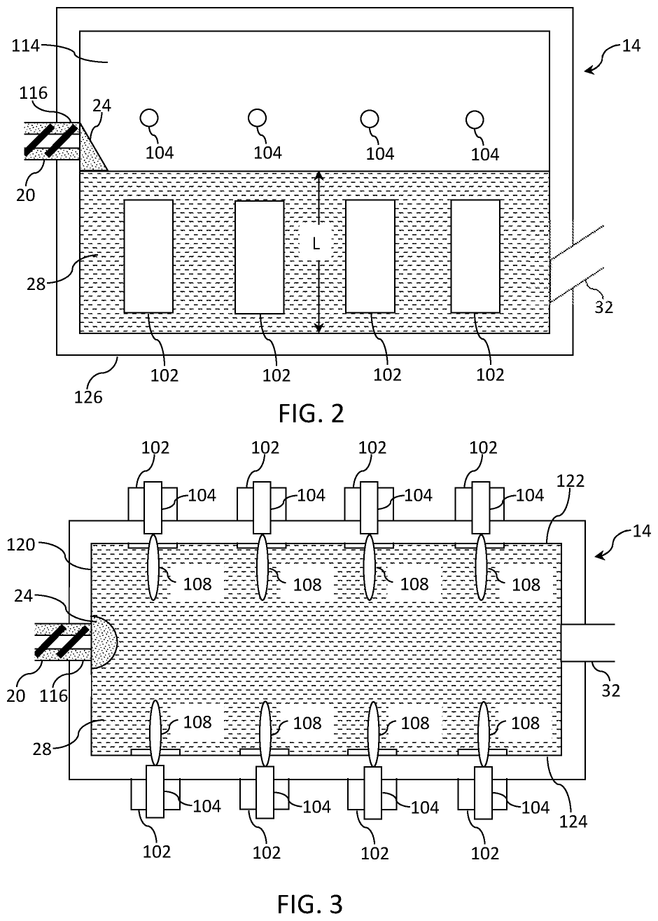

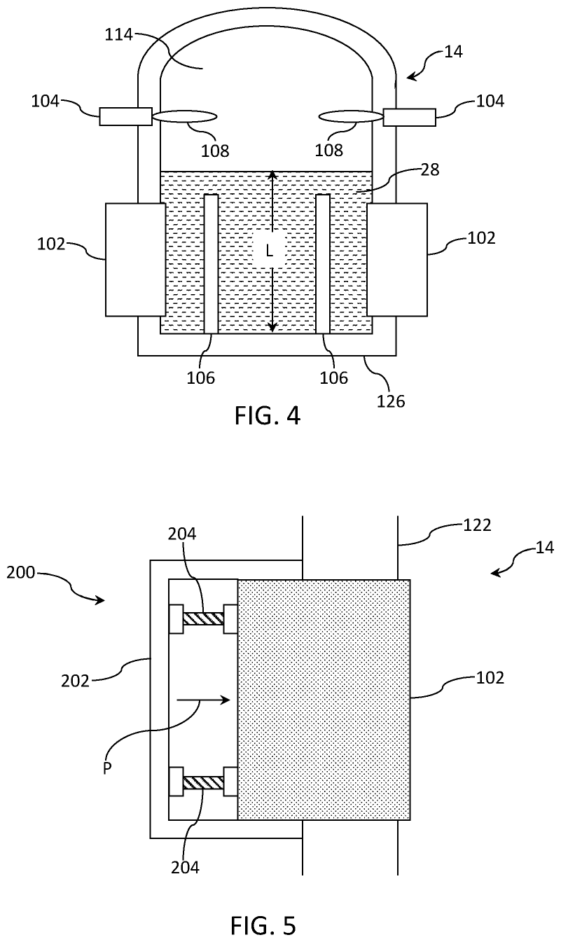

FIGS. 3 and 4, show, respectively, schematic top and end cutaway views of the example glass melting vessel 14 of FIG. 2. As can be seen in FIGS. 3 and 4, each combustion burner 104 emits a flame 108 into the chamber 114. In addition, as shown in FIG. 3, feed port 116 is positioned on a first wall 120 of the chamber 114 and the plurality of combustion burners 104 are positioned on second and third walls 122, 124 of the chamber 114, the second and third walls 122, 124 each extending in directions that are generally parallel to each other and generally perpendicular to the first wall 120. First, second, and third walls, 120, 122, and 124 are also generally perpendicular to floor 126.

As shown in FIG. 4, glass melting vessel 14 includes electrodes 106 extending from floor 126, wherein electrodes 106 are positioned below the predetermined depth (L). As further shown in FIG. 4, combustion burners 104 emit flames 108 in a direction that is generally parallel to predetermined depth (L).

While FIGS. 2-4 show a glass melting vessel 14 that includes electrodes 102 extending from walls of chamber 114, electrodes 106 extending from floor 126, and combustion burners 104, embodiments disclosed herein can include those in which glass melting vessel 14 does not include one or more of these components. Collectively, one or more of these components comprise a heating mechanism.

In certain exemplary embodiments, electrodes 102 and/or electrodes 106 comprise at least one of tin oxide or molybdenum. In certain exemplary embodiments, electrodes 102 comprise tin oxide and electrodes 106 comprise molybdenum.

FIG. 5 shows a schematic side cutaway view of an electrode 102 and pushing mechanism 200. Pushing mechanism 200 includes pushing frame 202 and driving components 204 that are configured to push electrode 102 as indicated by arrow P such that a portion of electrode 102 extends beyond wall 122 of melting vessel 14 as electrode 102, for example, corrodes over time due to exposure to molten glass.

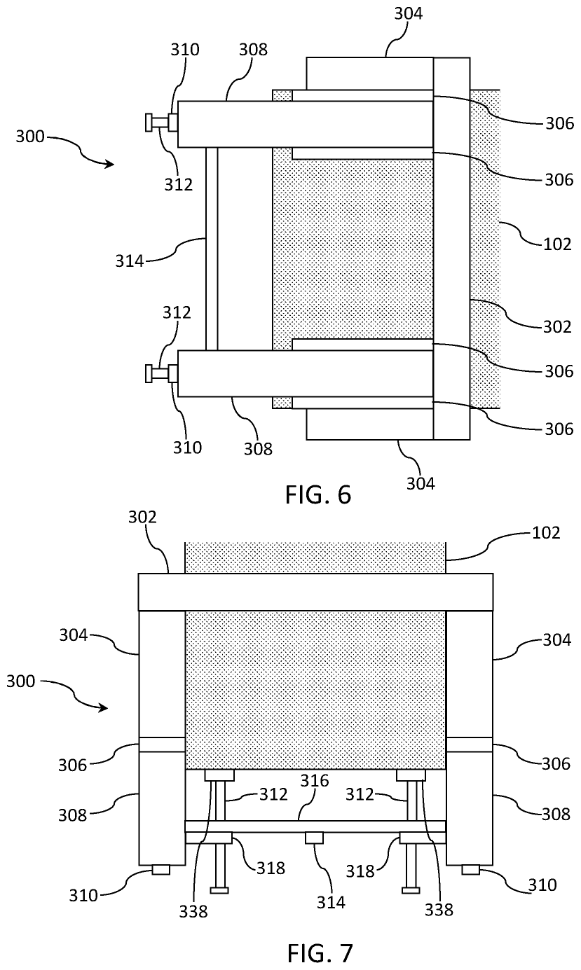

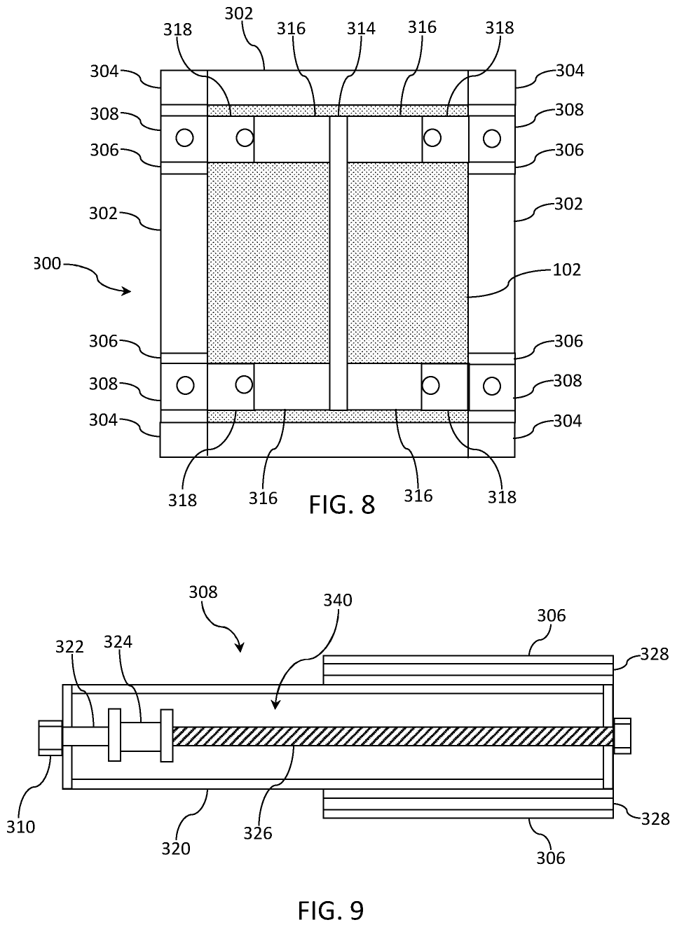

FIGS. 6-8 show, respectively, schematic side, top, and end views of an exemplary electrode 102 and pushing assembly 300 in accordance with embodiments disclosed herein. Pushing assembly 300 includes frame assembly 302 and support members 304 fixedly attached to frame assembly 302. Pushing assembly 300 also includes a plurality of driving assemblies 308 (two of which are shown in FIG. 6, two of which are shown in FIG. 7, and four of which are shown in FIG. 8) fixedly coupled to frame assembly 302. Each of the plurality of driving assemblies 308 includes a drive nut 310 and a pair of attachment sleeves 306 that facilitate attachment of each driving assembly 308 to frame assembly 302. Pushing assembly 300 additionally includes push frame 314 coupled to the plurality of driving assemblies 308 via removable bearings 318. Push frame 314 includes frame members 316 and push rods 312 extending through frame members 316 and configured to exert a pushing force against electrode 102 via electrode contacts 338.

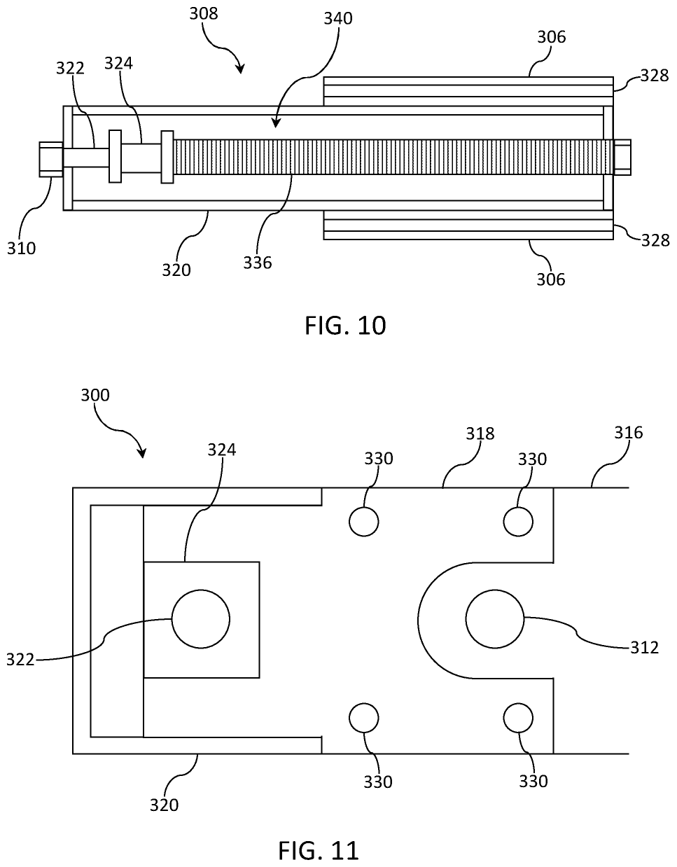

FIGS. 9 and 10 show schematic side views of an exemplary driving assembly 308 in accordance with embodiments disclosed herein. Driving assembly 308 includes a drive mechanism 340 housed within enclosure 320. Drive mechanism 340 includes axially extending drive shaft 322, which includes threaded region 326, and a drive bearing 324 that circumferentially surrounds an axial length of the drive shaft 322. Drive bearing 324 can be slip fit over drive shaft 322 allowing drive shaft 322 to freely rotate while drive bearing 324 remains in a fixed orientation. For example, drive shaft 322 can be rotated by turning drive nut 310 by either manual or mechanical (e.g., automated) action, which can in turn cause drive shaft 322 to move in an axial direction relative to enclosure 320 due to rotation of threaded region 326 through end wall of enclosure 320. Attachment sleeves 306 of driving assembly each include channels 328 for receiving attachment rods 334 (shown in FIGS. 13-15).

As shown in FIG. 10, drive mechanism 340 includes flexible cover 336 that circumferentially surrounds an axial length of drive shaft 322. Specifically, flexible cover 336 circumferentially surrounds threaded region 326, thereby protecting it from dust and debris that may be present in the vicinity of pushing assembly 300. Such protection can facilitate the free rotation of drive shaft 322 (e.g., protect the drive shaft from locking or freezing up due to dust or debris on threaded region 326). In certain exemplary embodiments, flexible cover 336 can have a bellows or accordion structure, which can enable it to expand or contract with axial movement of drive shaft 322 relative to enclosure 320. In certain exemplary embodiments, flexible cover 336 can comprise at least one of aluminum, fiberglass, or composites or multilayers of the same.

FIG. 11 shows a schematic end cutaway view of a portion of an exemplary electrode pushing assembly 300 in accordance with embodiments disclosed herein. Specifically, FIG. 11 shows removable bearing 318 coupled to drive bearing 324 and frame member 316 via attachment bolts 330 wherein removable bearing 318 extends between drive shaft 322 (housed within enclosure 320) and push rod 312.

In operation, driving assemblies 308 are configured to move push frame 314 by, for example, rotating drive shaft 322 (e.g., by turning drive nut 310) thereby causing drive shaft 322 to move in an axial direction, which, in turn, moves push frame 314 in the axial direction as a result of coupling between drive bearing 324, removable bearing 318, and frame member 316. For example, each driving assembly 308 of electrode pushing assembly 300 can move push frame 314 by rotating the drive shaft 322 of each driving assembly 308, thereby moving electrode 102 as a result of pushing force exerted on electrode 102 by push frame 314.

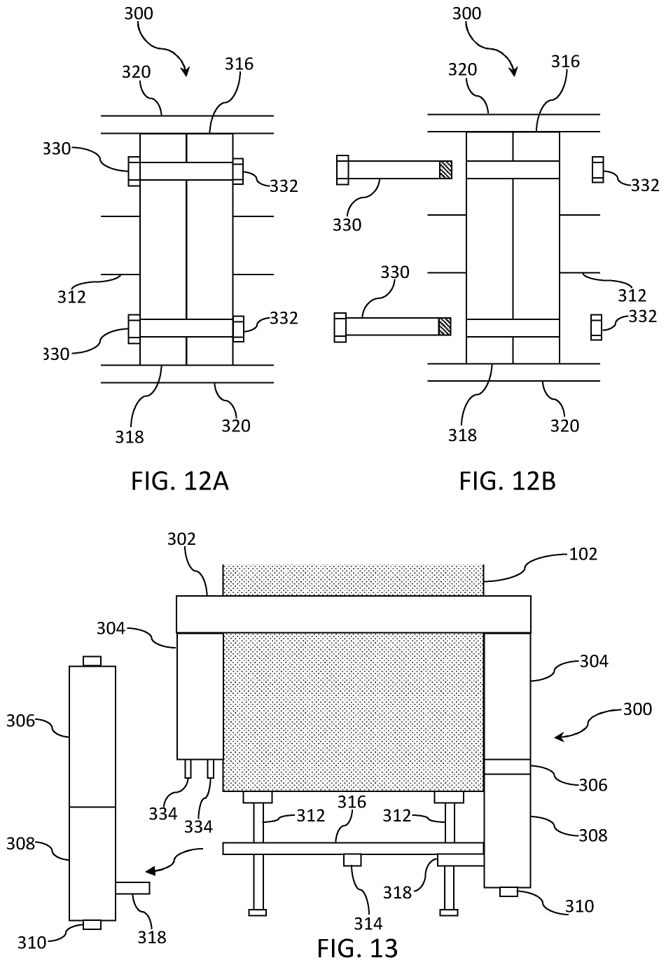

FIGS. 12A and 12B show schematic side cutaway views of a portion of an exemplary electrode pushing assembly 300 in accordance with embodiments disclosed herein. Specifically, FIG. 12A shows a schematic side cutaway view wherein removable bearing 318 is attached to frame member 316 via attachment bolts 330 and attachment nuts 332 (wherein removable bearing 318 and frame member 316 each extend around push rod 312). FIG. 12B shows a schematic side cutaway view wherein attachment bolts 330 and attachment nuts 332 have been removed from removable bearing 318 and frame member 316 thereby enabling separation of removable bearing 318 from frame member 316.

FIG. 13 shows a schematic top view of an exemplary electrode 102 and pushing assembly 300 wherein a driving assembly 308 has been removed in accordance with embodiments disclosed herein. Specifically, separation of removable bearing 318 from frame member 316 facilitates removal of driving assembly 308 from frame assembly 302 and push frame 314. Such removal includes separation of attachment sleeves 306 from attachment rods 334 which can include removal of a nut member (not shown) from ends of attachment rods 334 prior to removal of driving assembly 308.

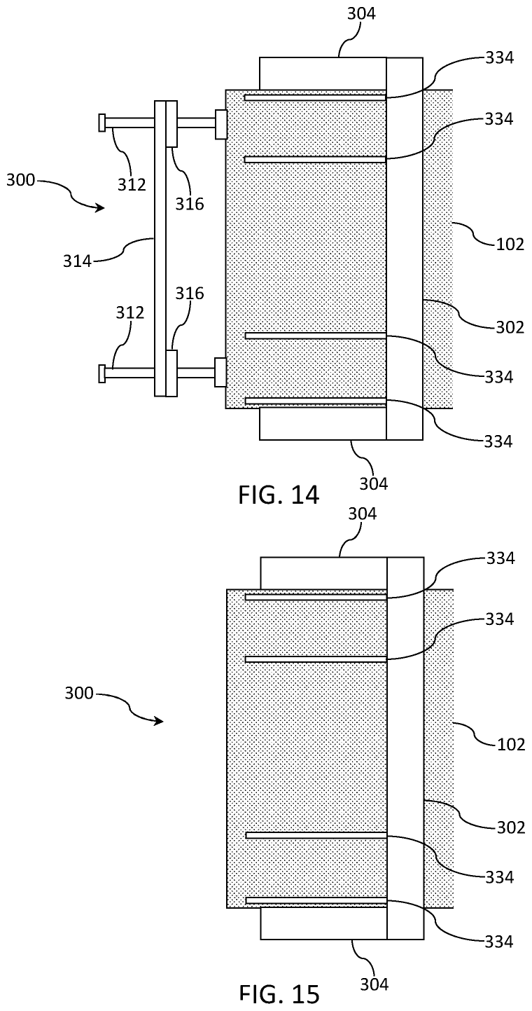

FIG. 14 shows a schematic side view of an exemplary electrode 102 and pushing assembly 300 wherein a plurality of driving assemblies 308 have been removed in accordance with embodiments disclosed herein. Specifically, all four driving assemblies 308 of pushing assembly 300 have been removed from frame assembly 302 and push frame 314 in the manner shown and described with respect to FIG. 13. Accordingly, plurality of driving assemblies 308 are each independently removable from frame assembly 302 and push frame 314.

FIG. 15 shows a schematic side view of an exemplary electrode 102 and pushing assembly 300 wherein a plurality of driving assemblies 308 and a push frame 314 have been removed in accordance with embodiments disclosed herein. Specifically, after driving assemblies 308 have been removed from frame assembly 302 and push frame 314, push frame 314 can also be removed from pushing assembly 300.

Embodiments disclosed herein can enable repair and/or replacement of pushing assembly 300 components, such as driving assembly 308 components, without requiring substantial disassembly of pushing assembly 300, which in turn, can enable operation of pushing assembly 300 and, in turn, melting vessel 14 with reduced expense and minimized process downtime. Embodiments disclosed herein can also enable increased physical access to electrode 102 without requiring substantial disassembly of pushing assembly 300.

While the above embodiments have been described with reference to fusion down draw processes, it is to be understood that such embodiments are also applicable to other glass forming processes, such as slot draw processes, float processes, up-draw processes, and press-rolling processes.

Such processes can be used to make glass articles, which can be used, for example, in electronic devices as well as for other applications.

It will be apparent to those skilled in the art that various modifications and variations can be made to embodiments of the present disclosure without departing from the spirit and scope of the disclosure. Thus, it is intended that the present disclosure cover such modifications and variations provided they come within the scope of the appended claims and their equivalents.

1. An electrode pushing assembly comprising:
a frame assembly;
a plurality of driving assemblies fixedly coupled to the frame assembly; and
a push frame coupled to the plurality of driving assemblies and configured to exert a pushing force against the electrode; and
wherein the plurality of driving assemblies are configured to move the push frame and are each independently removable from the frame assembly and the push frame.

2. The electrode pushing assembly of claim 1, wherein the push frame is coupled to each of the plurality of driving assemblies via a removable bearing.

3. The electrode pushing assembly of claim 2, wherein each of the plurality of driving assemblies comprises a drive bearing coupled to the removable bearing.

4. The electrode pushing assembly of claim 3, wherein each of the plurality of driving assemblies comprises a drive mechanism comprising an axially extending drive shaft.

5. The electrode pushing assembly of claim 4, wherein the drive bearing circumferentially surrounds an axial length of the drive shaft.

6. The electrode pushing assembly of claim 4, wherein the drive mechanism comprises a flexible cover that circumferentially surrounds an axial length of the drive shaft.

7. The electrode pushing assembly of claim 4, wherein each of the plurality of driving assemblies is configured to move the push frame by rotating the drive shaft.

8. A method of pushing an electrode comprising:
exerting a pushing force against the electrode with a push frame that is coupled to a plurality of driving assemblies, the plurality of driving assemblies fixedly coupled to a frame assembly, wherein the plurality of driving assemblies move the push frame and are each independently removable from the frame assembly and the push frame.

9. The method of claim 8, wherein the push frame is coupled to each of the plurality of driving assemblies via a removable bearing.

10. The method of claim 9, wherein each of the plurality of driving assemblies comprises a drive bearing coupled to the removable bearing.

11. The method of claim 10, wherein each of the plurality of driving assemblies comprises a drive mechanism comprising an axially extending drive shaft.

12. The method of claim 11, wherein the drive bearing circumferentially surrounds an axial length of the drive shaft.

13. The method of claim 11, wherein the drive mechanism comprises a flexible cover that circumferentially surrounds an axial length of the drive shaft.

14. The method of claim 11, further comprising moving the push frame by rotating the drive shaft of each of the plurality of driving assemblies.

15. A glass manufacturing apparatus comprising the electrode pushing assembly of claim 1.
